(19) United States
(12) Patent Application Publication
(10) Pub. No.: US 2014/0239903 A1
(43) Pub. Date: Aug. 28, 2014

(54) POWER CONVERSION DEVICE HAVING BATTERY HEATING FUNCTION

(71) Applicant: SAMSUNG SDI CO., LTD., Yongin-si (KR)

(72) Inventor: Sun-Ho CHOI, Yongin-si (KR)

(21) Appl. No.: 13/942,952

(22) Filed: Jul. 16, 2013

(30) Foreign Application Priority Data
Feb. 28, 2013 (KR) 10-2013-0022083

(51) Int. Cl. H01M 10/657; H02J 7/00

(52) U.S. Cl. CPC H01M 10/5081; H02J 7/0068
USPC 320/128

(57) ABSTRACT

A power conversion device having a battery heating function includes a battery, a bidirectional converter including a first circuit unit coupled between the battery and a DC link, a switch between a second node and a first node to which the first circuit unit and the battery are coupled, and second and third circuit units each coupled between the second node and the DC link; and a controller controlling the bidirectional converter to heat the battery in a battery heating mode.

### CROSS-REFERENCE TO RELATED APPLICATION

The present application claims priority under 35 U.S.C. §119 to and the benefit of Korean Patent Application No. 10-2013-0022083, filed on Feb. 28, 2013, in the Korean Intellectual Property Office, and entitled: “Power Conversion Device Having Battery Heating Function,” which is incorporated by reference herein in its entirety.

### BACKGROUND

1. Field

Embodiments relate to a power conversion device, and more particularly, to a power conversion device having a battery heating function.

2. Description of the Related Art

As environmental disruption, resource depletion, etc. are problematic, interest in an energy storage system capable of storing energy and efficiently using the stored energy is increased. A battery for storing and supplying electric power according to the amount of a load is included in the energy storage system. The battery may receive electric power supplied from an external power source so as to store the electric power, and may supply the stored electric power to an external load.

However, when the temperature of the battery is low due the influence of an intense cold region or ambient environment, e.g., a cold winter, the operating state of an electrolyte or the like of the battery is not quickly activated, and therefore, the operation of the battery is not normally performed.

### SUMMARY

One or more embodiments are directed to providing a power conversion device having a battery heating function, including a battery, a bidirectional converter including a first circuit unit coupled between the battery and a DC link, a relay positioned between a second node and a first node to which the first circuit unit and the battery are coupled, and second and third circuit units each coupled between the second node and the DC link; and a controller controlling the bidirectional converter to heat the battery in a battery heating mode.

The controller may turn off the switch during the battery heating mode.

The switch may be a relay and the controller may open the relay during the battery heating mode.

The power conversion device may further include a temperature sensor measuring a temperature of the battery.

The controller may determine whether to enter into the battery heating mode, based on the temperature of the battery, measured by the temperature sensor.

The first circuit unit may include a first inductor coupled between the first node and a third node; a first switching element coupled between the third node and the DC link; and a second switching element coupled between the third node and a ground power source.

The second circuit unit may include a second inductor coupled between the second node and a fourth node; a third switching element coupled between the fourth node and the DC link; and a fourth switching element coupled between the fourth node and the ground power source.

The third circuit unit may include a third inductor coupled between the second node and a fifth node; a fifth switching element coupled between the fifth node and the DC linker; and a sixth switching element coupled between the fifth node and the ground power source.

The controller may control the first circuit unit so that the battery repeats charging and discharging operations during the battery heating mode.

The controller may perform switching on the first switching element while maintaining the second switching element to be in an off-state in order to perform the charging operation of the battery during the battery heating mode.

The controller may perform switching on the second switching element while maintaining the first switching element to be in the off-state in order to perform the discharging operation of the battery during the battery heating mode.

Each switching element may be a transistor.

Each circuit unit may further include a recovery diode coupled in parallel to each switching element.

Each of the first, second, and third circuit units may include a first connection to a positive pole of the DC link, a second connection common to a negative pole of the battery and a negative pole of the DC link, a pair of switching elements coupled in series between the first connection and the second connection, and an inductor, one end of the inductor being coupled to a node between each of the pair of switching elements, and another end of the inductor being coupled to a positive pole of the battery when the switch is on.

The bidirectional converter may be configured to cyclically store power from the battery and discharge power to the battery during the battery heating mode.

One or more embodiments is directed to a system, including a bidirectional converter including a first circuit unit to be coupled between a battery and a DC link, a switch positioned between a second node and a first node to which the first circuit unit and the battery are coupled, and second and third circuit units each coupled between the second node and the DC link, and a controller controlling the bidirectional converter in a battery heating mode, thereby heating the battery.

### BRIEF DESCRIPTION OF THE DRAWINGS

Features will become apparent to those of skill in the art by describing in detail example embodiments with reference to the attached drawings in which:

FIG. 1 illustrates a block diagram of a power conversion device according to an embodiment.

FIG. 2 illustrates a circuit diagram of a bidirectional converter according to an embodiment.

FIG. 3 illustrates a block diagram of an energy storage system employing the power conversion device according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey example implementations to those skilled in the art. Like reference numerals refer to like elements throughout.

Hereinafter, a power conversion device having a battery heating function according to embodiments will be described with reference to the accompanying drawings.

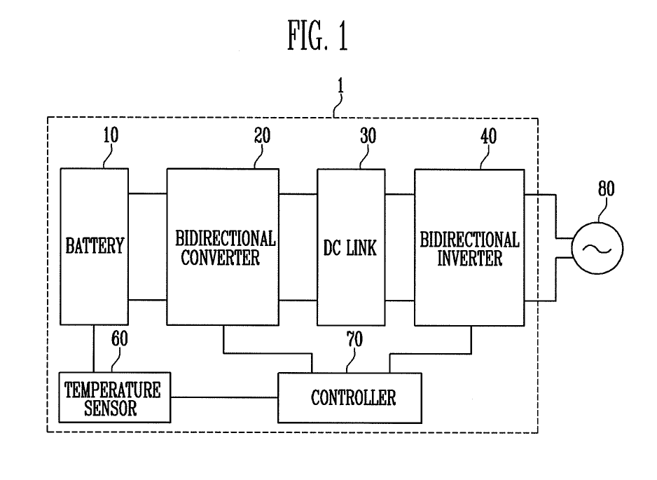

FIG. 1 illustrates a block diagram of a power conversion device according to an embodiment. Referring to FIG. 1, the power conversion device 1 having a battery heating function (hereinafter, referred to as a power conversion device) includes a battery 10, a bidirectional converter 20, a DC link 30, and a controller 70.

The battery 10 may be a secondary battery which may be charged and discharged. By way of non-limiting examples, the battery 10 may be a nickel-cadmium battery, a lead storage battery, a nickel metal hydride battery (NiMH), a lithium ion battery, a lithium polymer battery, etc.

The bidirectional converter 20 is coupled between the battery 10 and the DC link 30. The bidirectional converter 20 may convert DC power having one level from the DC link 30 into DC power having another level suitable for the battery 10 and transmit the converted DC power to the battery 10. Additionally, the bidirectional converter 20 may convert DC power having one level from the battery 10 into DC power having another level suitable for the DC link 30 and transmit the converted DC power to the DC link 30. The bidirectional converter 20 may generate a charging/discharging path of the battery 10 between the battery 10 and the DC link 30 under the control of the controller 70.

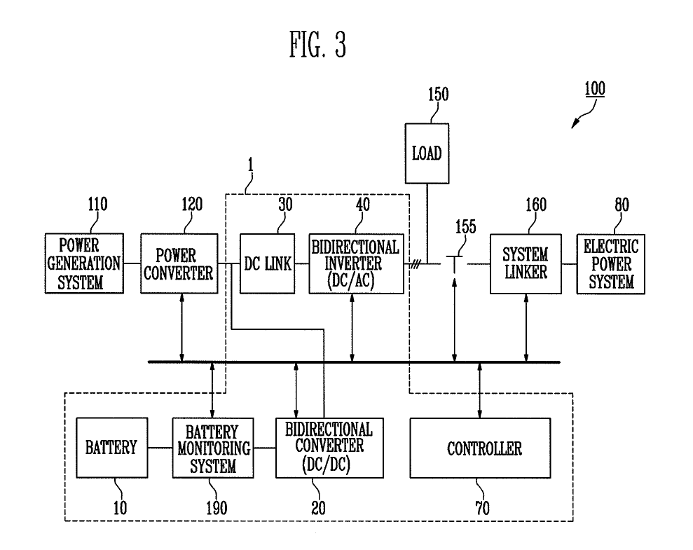

The battery 10 may be coupled to the bidirectional converter 20 through a battery monitoring system 190 (see FIG. 3).

The DC link 30 may perform a function of temporarily storing DC power output from the bidirectional converter 20 and transmitting the stored power to another component (e.g., a bidirectional inverter 40). The DC link 30 may perform a function of storing DC power output from the bidirectional inverter 40 and transmitting the stored power to the bidirectional converter 20. The bidirectional inverter 40 may convert DC power provided from the DC link 30 into AC power and output the converted AC power to an electric power system 80, etc.

The controller 70 may heat the battery 10 by controlling the bidirectional converter 20 during a battery heating mode so that the battery 10 may be normally operated.

Whether to operate in a general driving mode or in the battery heating mode may be determined according to the temperature of the battery 10. To determine the temperature of the battery 10, the power conversion device may further include a temperature sensor 60. The temperature sensor 60 measures a temperature of the battery 10 and transmits the measured temperature to the controller 70.

Accordingly, the controller 70 may determine whether to enter into the battery heating mode according to the measured temperature of the battery 10.

When the temperature of the battery 10 is less than or equal to a predetermined reference value, the controller 70 may perform the battery heating mode. When the temperature of the battery 10 exceeds the predetermined reference value so that the battery 10 is normally operated, the controller 70 may perform the general driving mode.

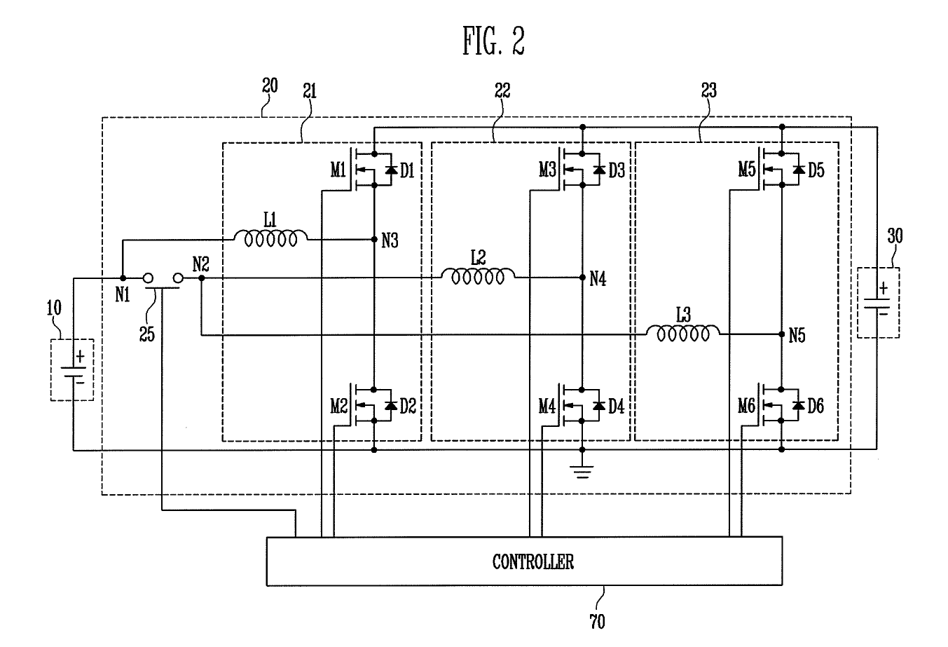

FIG. 2 illustrates a circuit diagram of the bidirectional converter according to an example embodiment. Referring to FIG. 2, the bidirectional converter 20 according to this embodiment may include a first circuit unit 21, a second circuit unit 22, a third circuit unit 23, and a switch, e.g., a relay 25.

The first circuit unit 21 may be coupled between the battery 10 and the DC link 30. For example, the first circuit unit 21 may be electrically coupled to a positive (+) electrode of the battery 10. Each of the second and third circuit units 22 and 23 may be coupled between a second node N2 and the DC link 30.

The relay 25 may be coupled between the second node N2 and a first node N1 to which the first circuit unit 21 and the battery 10 are coupled. In this case, the first node N1 may be defined as a common contact of the battery 10, the relay 25, and the first circuit unit 21.

The second node N2 may be defined as a common contact of the relay 25, the second circuit unit 22, and the third circuit unit 23. The on-off operation of the relay 25 may be controlled by the controller 70.

The operations of the first, second and third circuit units 21, 22, and 23 may be controlled by the controller 70. The controller 70 may control the first circuit unit 21 so that the battery 10 repeats charging and discharging operations during the battery heating mode.

The relay 25 may be maintained in an open or off-state during the battery heating mode so that the second and third circuit units 22 and 23 are not involved in the charging and discharging operations of the battery 10. Accordingly, the battery heating operation may be performed using only some of the circuits in the bidirectional converter 20.

As the first circuit unit 21 performs the charging and discharging operations, current ripples are generated in the DC link 30, and accordingly, the DC link 30 receives stress. During general driving mode, the controller 70 may control the second and third circuit units 22 and 23 so as to offset current stress of the DC link 30. That is, the controller 70 may offset the current stress of the DC link 30 by controlling switching phases of the first, second, and third circuit units 21, 22, and 23. The first circuit unit 21 may include a first inductor L1, a first switching element Ml, and a second switching element M2.

The first inductor L1 may be coupled between the first node N1 and a third node N3. The first switching element M1 may be coupled between the third node N3 and the DC link 30. The second switching element M2 may be coupled between the third node N3 and a ground power source. In this case, the first node N1 may be defined as a common contact of the battery 10, the first inductor L1, and the relay 25.

The third node N3 may be defined as a common contact of the first inductor L1, the first switching element M1, and the second switching element M2. The on-off operations of the first and second switching elements Ml and M2 may be controlled by the controller 70.

For example, a first electrode of the first switching element M1 may be coupled to a positive (+) terminal of the DC link 30 and a second electrode of the first switching element M1 may be coupled to the third node N3. A control electrode of the first switching element M1 may be coupled to the controller 70.

A first electrode of the second switching element M2 may be coupled to the third node N3 and a second electrode of the second switching element M2 may be coupled to the ground power source. A control electrode of the second switching element M2 may be coupled to the controller 70.

Recovery diodes D1 and D2 may be coupled in parallel to the respective switching elements M1 and M2. In particular, a first recovery diode D1 may be coupled in parallel to the first switching element M1 and a second recovery diode D2 may be coupled in parallel to the second switching element M2. More specifically, an anode of the first recovery diode D1 may be coupled to the second electrode of the first switching element M1 and a cathode of the first recovery diode D1 may be coupled to the first electrode of the first switching element M1. An anode of the second recovery diode D2 may be coupled to the second electrode of the second switching element M2, and a cathode of the second recovery diode D2 may be coupled to the first electrode of the second switching element M2.

The first and second switching elements M1 and M2 may be implemented as transistors.

In order to perform a charging operation of the battery 10 during the battery heating mode, the controller 70 may perform switching on the first switching element M1 while maintaining the second switching element M2 to be in the off-state.

For example, the controller 70 may perform switching on the first switching element M1 while maintaining the second switching element M2 to be in the off-state during a predetermined charging period. Accordingly, the first circuit unit 21 may be operated in a buck mode.

When the first switching element M1 is turned on during the charging period, a current path may be formed from the DC link 30 to the battery 10 via the first switching element M1 and the first inductor L1. When the first switching element M1 is turned off, a current path may be formed from the first inductor L1 to the battery 10 via the second recovery diode D2. Thus, the battery 10 may perform the charging operation during the battery heating mode.

In order to perform a discharging operation of the battery 10 during the battery heating mode, the controller 70 may perform switching on the second switching element M2 while maintaining the first switching element M1 to be in the off-state.

For example, the controller 70 may perform switching on the second switching element M2 while maintaining the first switching element M1 to be in the off-state during a predetermined discharging period. Accordingly, the first circuit unit 21 may be operated in a boost mode.

When the second switching element M2 is turned on during the discharging period, a current path may be formed from the battery 10 to the second switching element M2 through the first inductor L1. When the second switching element M2 is turned off, a current path may be formed from the battery 10 to the DC link 30 via the first inductor L1 and the first recovery diode D1.

Thus, the battery 10 may perform the discharging operation during the battery heating mode.

The charging and discharging operations of the battery 10 are repetitively performed during the battery heating mode, and accordingly, the temperature of the battery 10 is increased.

When the temperature of the battery 10, measured through the temperature sensor 60, reaches a predetermined level, the controller 70 may finish the battery heating mode and return to the general driving mode (charging mode or discharging mode).

The second circuit unit 22 may include a second inductor L2, a third switching element M3, and a fourth switching element M4. The second inductor L2 may be coupled between the second node N2 and a fourth node N4. The third switching element M3 may be coupled between the fourth node N4 and the DC link 30. The fourth switching element M4 may be coupled between the fourth node N4 and the ground power source. In this case, the second node N2 may be defined as a common contact of the relay 25, the second inductor L2, and a third inductor L3.

The fourth node N4 may be defined as a common contact of the second inductor L2, the third switching element M3, and the fourth switching element M4. The on-off operations of the third and fourth switching elements M3 and M4 may be controlled by the controller 70. Specifically, a first electrode of the third switching element M3 may be coupled to the positive (+) terminal of the DC link 30 and a second electrode of the third switching element M3 may be coupled to the fourth node N4. A control electrode of the third switching element M3 may be coupled to the controller 70.

A first electrode of the fourth switching element M4 may be coupled to the fourth node N4, and a second electrode of the fourth switching element M4 may be coupled to the ground power source. A control electrode of the fourth switching element M4 may be coupled to the controller 70.

Recovery diodes D3 and D4 may be coupled in parallel to the respective switching elements M3 and M4. In particular, a third recovery diode D3 may be coupled in parallel to the third switching element M3 and a fourth recovery diode D4 may be coupled in parallel to the fourth switching element M4.

Specifically, an anode of the third recovery diode D3 may be coupled to the second electrode of the third switching element M3 and a cathode of the third recovery diode D3 may be coupled to the first electrode of the third switching element M3. An anode of the fourth recovery diode D4 may be coupled to the second electrode of the fourth switching element M4, and a cathode of the fourth recovery diode D4 may be coupled to the first electrode of the fourth switching element M4.

The third and fourth switching elements M3 and M4 may be implemented as transistors.

The third circuit unit 23 may include the third inductor L3, a fifth switching element M5, and a sixth switching element M6. The third inductor L3 may be coupled between the second node N2 and a fifth node N5. The fifth switching element M5 may be coupled between the fifth node N5 and the DC link 30. The sixth switching element M6 may be coupled between the fifth node N5 and the ground power source. In this case, the fifth node N5 may be defined as a common contact of the third inductor L3, the fifth switching element M5, and the sixth switching element M6.

The on-off operations of the fifth and sixth switching elements M5 and M6 may be controlled by the controller 70. Specifically, a first electrode of the fifth switching element M5 may be coupled to the positive (+) terminal of the DC link 30 and a second electrode of the fifth switching element M5 may be coupled to the fifth node N5. A control electrode of the fifth switching element M5 may be coupled to the controller 70.

Recovery diodes D5 and D6 may be coupled in parallel to the respective switching elements M5 and M6. In particular, a fifth recovery diode D5 may be coupled in parallel to the fifth switching element M5, and a sixth recovery diode D6 may be coupled in parallel to the sixth switching element M6.

For example, an anode of the fifth recovery diode D5 may be coupled to the second electrode of the fifth switching element M5 and a cathode of the fifth recovery diode D5 may be coupled to the first electrode of the fifth switching element M5. An anode of the sixth recovery diode D6 may be coupled to the second electrode of the sixth switching element M6, and a cathode of the sixth recovery diode D6 may be coupled to the first electrode of the sixth switching element M6.

The fifth and sixth switching elements M5 and M6 may be implemented as transistors.

As would be apparent from one of ordinary skill in the art from the forgoing, during a general driving mode, the controller 70 may control the relay 25 to maintain a closed or on-state and may control the first to third circuit units 21-23 so as to offset current stress of the DC link 30. That is, the controller 70 may offset the current stress of the DC link 30 by controlling switching phases of the first, second, and third circuit units 21, 22, and 23 during a general driving mode.

FIG. 3 illustrates a block diagram showing an energy storage system employing the power conversion device according to an embodiment. Referring to FIG. 3, the energy storage system 100 may include a power conversion device 1, a power generation system 110, a power converter 120, a load 150, a system linker 160, and an electric power system 80.

The power generation system 110 generates electrical energy and supplies the generated electrical energy to the energy storage system 100. The power generation system 110 may be a new energy and renewable energy generation system using renewable energy including sunlight, water, subterranean heat, rainfall, living organism, etc.

For example, the power generation system 110 may be a solar generation system that converts solar energy such as solar heat and sunlight into electrical energy through solar cells. In addition, the power generation system 110 may be a wind power generation system for converting wind power into electrical energy, a subterranean heat generation system for converting subterranean heat into electrical energy, a hydraulic power generation system, or an ocean power generation system.

The power generation system may be a new energy generation system that produces electrical energy using fuel cells or produces electrical energy using hydrogen, coal liquefied gas or medium quality residual oil gas.

It will be apparent that the power generation system 110 may be implemented in various manners in addition to the aforementioned embodiment.

The power converter 120 is coupled between the power generation system 110 and the DC link 30. The power converter 120 converts electric power generated in the power generation system 110 into DC voltage.

The operation of the power converter 120 is changed depending on the electric power generated in the power generation system 110. For example, when the power generation system 110 generates AC voltage, the power converter 120 converts the AC voltage into DC voltage. When the power generation system 110 generates DC voltage, the power converter 120 boosts or drops the DC voltage to DC voltage.

For example, when the power generation system 110 is a solar generation system, the power converter 120 may be a maximum power point tracking (MPPT) converter that detects the maximum power point according to a change in the amount of sunlight or a change in the temperature of solar heat and generates electric power. In addition, various kinds of converters or rectifiers may be used as the power converter 120.

The DC link 30 temporarily stores DC voltage provided from the power converter 120. The DC link 30 may be substantially a large-capacity capacitor. Thus, the DC link 30 stores stabilized DC power by removing an AC component from the DC power output from the power converter 120. In addition, the DC link 30 also stabilizes DC voltage provided from the bidirectional inverter 40 or the bidirectional converter 20 described later and temporarily stores the stabilized DC voltage.

The bidirectional inverter 40 converts the DC power provided from the DC link 30 into commercial AC power and outputs the converted AC power. Substantially, the bidirectional inverter 40 converts DC voltage from the power generation system 110 or the battery 10 into commercial AC voltage available in a home and outputs the converted AC voltage. The bidirectional inverter 40 converts commercial AC voltage provided from the electric power system 80 into DC power and provides the converted DC power to the DC link 30. The electric power stored in the DC link 30 is provided to the battery 10 through the bidirectional converter 20.

The load 150 may be a home or industrial facility using commercial AC voltage. The load 150 receives commercial AC power applied from the power generation system 110, the battery 10 or the electric power system 80.

The system linker 160 couples the bidirectional inverter 40 and the electric power system 80. For example, the system linker 160 controls a voltage fluctuation range, restricts harmonics and removes a DC component, etc. The system linker 160 provides AC power of the bidirectional inverter 40 to the electric power system 80 or provides AC power of the electric power system 80 to the bidirectional inverter 40.

The electric power system 80 is an AC power system provided from an electric power company or power generation company. For example, the electric power system 80 is an electrical link formed in a wide area, including power stations, transformer substations and power transmission lines. The electric power system 80 is typically referred to as a grid.

The battery monitoring system 190 optimally maintains and manages the state of the battery 10. For example, the battery monitoring system 190 monitors the voltage, current and temperature of the battery 10. When an error occurs in the battery 10, the battery monitoring system 190 warns a user of the error. In addition, the battery monitoring system 190 calculates the state of charge (SOC) and state of health (SOH) of the battery 10, and performs cell balancing of equalizing the voltage or capacity of each battery. The battery monitoring system 190 controls a cooling fan (not shown) in order to prevent overheating of the battery 10.

The temperature sensor 60 capable of measuring a temperature of the battery 10 may be included in the battery monitoring system 190.

The bidirectional converter 20 converts DC power having one level from the DC link 30 into DC power having another level suitable for the battery 10. The bidirectional converter 20 converts DC power having one level from the battery 10 into DC power having another level suitable for the DC link 30.

The controller 70 monitors and controls the power converter 120, the bidirectional inverter 40, the system linker 160, the bidirectional converter 20, and the like. The controller 70 monitors the battery monitoring system 190 by communicating with the battery monitoring system 190. In particular, the controller 70 may sense voltage, current, and temperature from each of the power converter 120, the bidirectional inverter 40, the system linker 160, and the bidirectional converter 20, and control each of the power converter 120, the bidirectional inverter 40, the system linker 160, and the bidirectional converter 20. In addition, the controller 70 may cut off a circuit breaker 155 coupled between the load 150 and the system linker 160 in an emergency situation.

By way of summation and review, embodiments provide a power conversion device capable of performing a battery heating function without using a separate heating device.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A power conversion device having a battery heating function, comprising:
a battery;
a bidirectional converter including a first circuit unit coupled between the battery and a DC link, a switch between a second node and a first node to which the first circuit unit and the battery are coupled, and second and third circuit units each coupled between the second node and the DC link; and
a controller controlling the bidirectional converter to heat the battery₋in a battery heating mode.

2. The power conversion device of claim 1, wherein the controller turns on the switch.

3. The power conversion device of claim 1, wherein the switch is a relay and the controller opens the relay during the battery heating mode.

4. The power conversion device of claim 1, further comprising a temperature sensor for measuring a temperature of the battery.

5. The power conversion device of claim 3, wherein the controller is coupled to the temperature sensor and the controller determines whether to enter into the battery heating mode based on a temperature of the battery measured by the temperature sensor.

6. The power conversion device of claim 1, wherein the first circuit unit includes:
a first inductor coupled between the first node and a third node;
a first switching element coupled between the third node and the DC link; and
a second switching element coupled between the third node and a ground power source.

7. The power conversion device of claim 6, wherein the second circuit unit includes:
a second inductor coupled between the second node and a fourth node;
a third switching element coupled between the fourth node and the DC link; and
a fourth switching element coupled between the fourth node and the ground power source.

8. The power conversion device of claim 7, wherein the third circuit unit includes:
a third inductor coupled between the second node and a fifth node;
a fifth switching element coupled between the fifth node and the DC link; and
a sixth switching element coupled between the fifth node and the ground power source.

9. The power conversion device of claim 8, wherein each of the first through sixth switching elements is a transistor.

10. The power conversion device of claim 8, wherein the each circuit unit further includes a recovery diode coupled in parallel to each switching element.

11. The power conversion device of claim 6, wherein the controller controls the first circuit unit so that the battery repeats charging and discharging operations during the battery heating mode.

12. The power conversion device of claim 11, wherein the controller performs switching on the first switching element while maintaining the second switching element to be in an off-state in order to perform the charging operation of the battery during the battery heating mode.

13. The power conversion device of claim 12, wherein the controller performs switching on the second switching element while maintaining the first switching element to be in the off-state in order to perform the discharging operation of the battery during the battery heating mode.

14. The power conversion device of claim 6, wherein each of the first and second switching elements is a transistor.

15. The power conversion device of claim 6, wherein the first circuit unit further includes a recovery diode coupled in parallel to each switching element.

16. The power conversion device of claim 1, wherein each of the first, second, and third circuit units includes:
a first connection to a positive pole of the DC link;
a second connection common to a negative pole of the battery and a negative pole of the DC link;
a pair of switching elements coupled in series between the first connection and the second connection; and
an inductor, one end of the inductor being coupled to a node between each of the pair of switching elements, and another end of the inductor being coupled to a positive pole of the battery when the switch is on.

17. The power conversion device of claim 1, wherein the bidirectional converter is configured to cyclically store power from the battery and discharge power to the battery during the battery heating mode.

18. A system, comprising:
a bidirectional converter including a first circuit unit to be coupled between a battery and a DC link, a switch between a second node and a first node to which the first circuit unit and the battery are coupled, and second and third circuit units each coupled between the second node and the DC link; and
a controller controlling the bidirectional converter to heat the battery in a battery heating mode.
